(19) United States
(12) Patent Application Publication
(10) Pub. No.: US 2025/0328400 A1
(43) Pub. Date: Oct. 23, 2025

(54) THREAD WEAVE FOR CROSS-INSTRUCTION SET ARCHITECTURE PROCEDURE CALLS

(71) Applicant: Magic Leap, Inc., Plantation, FL (US)

(72) Inventors: Jonathan Lindsey Tate, Beltram, TX (US); Gregory Michael Link, Charlotte, NC (US)

(73) Assignee: Magic Leap, Inc., Plantation, FL (US)

(21) Appl. No.: 19/258,152

(22) Filed: Jul. 2, 2025

Related U.S. Application Data
(62) Division of application No. 18/746,709, filed on Jun. 18, 2024, now Pat. No. 12,379,981.
Application No. 18/746,709 is a division of application No. 17/259,020, filed on Jan. 8, 2021, now Pat. No. 12,164,978.
(60) Provisional application No. 62/696,132, filed on Jul. 10, 2018.

(51) Int. Cl. G06F 9/54; G06F 8/41

(52) U.S. Cl. CPC G06F 9/547; G06F 8/47

(57) ABSTRACT

The invention provides a method of initiating code including (i) storing an application having first, second and third functions, the first function being a main function that calls the second and third functions to run the application, (ii) compiling the application to first and second heterogeneous processors to create first and second central processing unit (CPU) instruction set architecture (ISA) objects respectively, (iii) pruning the first and second CPU ISA objects by removing the third function from the first CPU ISA objects and removing first and second functions from the second CPU ISA objects, (iv) proxy inserting first and second remote procedure calls (RPC's) in the first and second CPU ISA objects respectively, and pointing respectively to the third function in the second CPU ISA objects and the second function in the first CPU ISA objects, and (v) section renaming the second CPU ISA objects to common application library.

### CROSS-REFERENCE TO RELATED APPLICATIONS

This application is a divisional of U.S. patent application Ser. No. 18/746,709, filed Jun. 18, 2024, which is a divisional of U.S. patent application Ser. No. 17/259,020, filed on Jan. 8, 2021 now U.S. Pat. No. 12,164,978, which is a National Phase of International Application No. PCT/US2019/041151, filed on Jul. 10, 2019, which claims priority from U.S. Provisional Patent Application No. 62/696,132, filed on Jul. 10, 2018, all of which are incorporated herein by reference in their entirety.

### BACKGROUND OF THE INVENTION

### 1). Field of the Invention

This invention relates to a method of initiating code, a method of executing an application, and a heterogeneous multiprocessor.

### 2). Discussion of Related Art

Complex computer systems frequently make use of a heterogeneous approach involving multiple processor cores from different vendors each with unique instruction set architectures. Generating code for a heterogeneous multiprocessor may be a difficult task for a programmer. A programmer will essentially have to deal with procedure calls that are separately compatible with two separate binary incompatible cores and deal with procedure calls that may transition from one thread to another at boundaries where the other processor may be more efficient. This kind of complexity makes it difficult for a software author to focus on functional correctness using conventional high-level computer language, such as high-level C++ threading primitives and libraries.

### SUMMARY OF THE INVENTION

The invention provides a method of initiating code including (i) storing an application in a memory, the application having first, second and third functions, the first function being a main function that calls the second and third functions to run the application, (ii) compiling the application to first and second heterogeneous processors to create first and second central processing unit (CPU) instruction set architecture (ISA) objects respectively, (iii) pruning the first and second CPU ISA objects by removing the third function from the first CPU ISA objects and removing first and second functions from the second CPU ISA objects, (iv) proxy inserting first and second remote procedure calls (RPC's) in the first and second CPU ISA objects respectively, and pointing respectively to the third function in the second CPU ISA objects and the second function in the first CPU ISA objects, and (v) section renaming the second CPU ISA objects to create a common application library of the first and second CPU ISA objects.

The invention also provides a computer-readable medium having stored thereon a set of instructions that are executable by a processor to carry out a method. The method may include (i) storing an application in a memory, the application having first, second and third functions, the first function being a main function that calls the second and third functions to run the first application, (ii) compiling the application to first and second heterogeneous processors to create first and second central processing unit (CPU) instruction set architecture (ISA) objects respectively, (iii) pruning the first and second CPU ISA objects by removing the third function from the first CPU ISA objects and removing first and second functions from the second CPU ISA objects, (iv) proxy inserting first and second remote procedure calls (RPC's) in the first and second CPU ISA objects respectively, and pointing respectively to the third function in the second CPU ISA objects and the second function in the first CPU ISA objects, and (v) section renaming the second CPU ISA objects to create a common application library of the first and second CPU ISA objects.

The invention further provides a method of executing an application including (1) executing a first function of an application that has first, second and third functions, the first function being a main function, on a first processor with at least one of first central processing unit (CPU) instruction set architecture (ISA) objects that are compiled to the first processor, the main function causing sequential execution of (2) a first remote procedure call (RPC) on the first processor with at least one of the first CPU ISA objects; (3) the third function on a second processor with at least one of second CPU ISA objects that are compiled to the second processor; (4) the second RPC on the second processor with at least one of the second CPU ISA objects, and (5) the second function on the first processor with at least one of the first CPU ISA objects.

The invention also provides a heterogeneous multiprocessor including first and second heterogeneous processors, a memory and an application on the memory, including first, second and third functions and first and second remote procedure calls (RPC), wherein (1) the first function is a main function that is executed on the first processor with at least one of first central processing unit (CPU) instruction set architecture (ISA) objects that are compiled to the first processor. The main function causing sequential execution of (2) the first RPC on the first processor with at least one of the first CPU ISA objects, (3) the third function on a second processor with at least one of second CPU ISA objects that are compiled to the second processor, (4) the second RPC on the second processor with at least one of the second CPU ISA objects and (5) the second function on the first processor with at least one of the first CPU ISA objects.

### BRIEF DESCRIPTION OF THE DRAWINGS

The invention is further described by way of example with reference to the accompanying drawings, wherein:

FIG. 1 is a block diagram illustrating a conceptual heterogeneous multiprocessor application;

FIGS. 2 to 6 are block diagrams illustrating development of a heterogeneous multiprocessor application;

FIGS. 7 to 11 illustrate runtime execution of a heterogeneous multiprocessor; and

FIG. 12 is a block diagram of a machine in the form of a computer that can host a build system for deploying heterogeneous multiprocessor application.

### DETAILED DESCRIPTION OF THE INVENTION

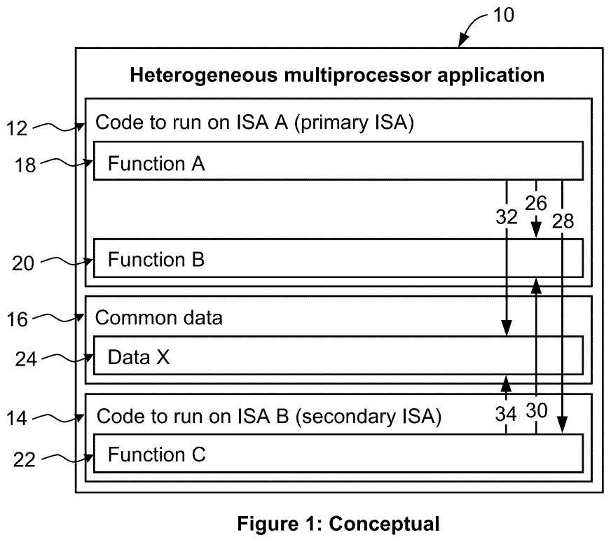

FIG. 1 illustrates a conceptual heterogeneous multiprocessor application 10, including code 12 to run on a primary instruction set architecture (ISA), code 14 to run on a secondary ISA and common data 16.

The code 14 includes first and second functions 18 and 20. The first function 18 is a main function, which is the first function that is executed to run the heterogeneous multiprocessor application 10. The code 14 includes a third function 22. The common data 16 includes a data structure 24. The first function 18 at 26 points to the second function 20 and, at 28, points at the third function 22. The third function 22, at 30, points to the second function 20. The first and third functions 18 and 22 rely on the data structure 24 at 32 and 34 respectively.

It will be understood that an application may have more than three functions. For purposes of discussion, the construction of a heterogeneous multiprocessor is described having only three functions, which is sufficient to describe the invention, and which does not include unnecessary clutter that may obscure the invention. Additional functions may however be included before, in between and/or after the three functions that are used in this description, and may call any other function in the system belonging to any ISA via the same methods.

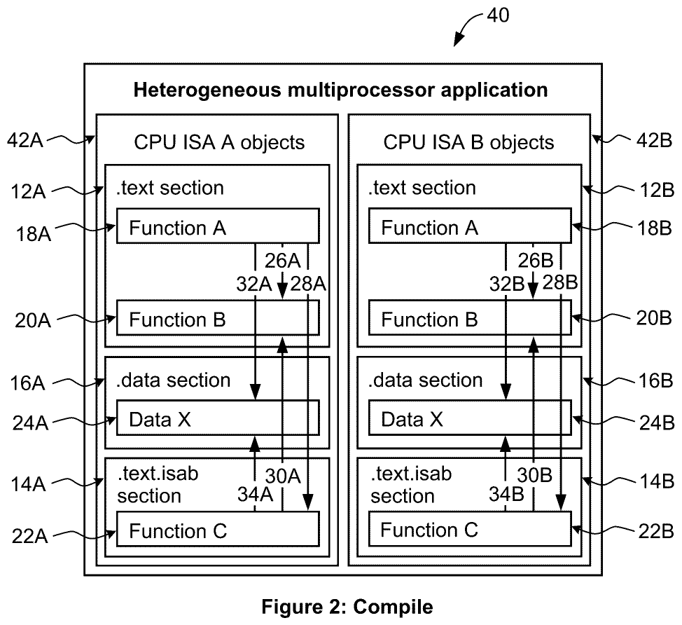

FIG. 2 illustrates a first operation to create a heterogeneous multiprocessor application 40, according to an embodiment of the invention. An application is written in source code and stored in memory. The application is then compiled to first and second heterogeneous processors to create first and second central processing unit (CPU) ISA objects 42A and 42B, respectively. The processors have different ISA's and therefore rely on objects that are different for their functioning. The CPU ISA objects 42A and 42B are thus different from one another in accordance with the different requirements of the ISA's of the different processors. The CPU ISA objects 42A and 42B are compiled from the same source code and thus have the same functional blocks. For example, the CPU ISA objects 42A include a first function 18A and the CPU ISA objects 42B also include a first function 18B. The functional components of the CPU ISA objects 42A and 42B are the same as the functional components of the conceptual heterogeneous multiprocessor application 10 described with reference to FIG. 1. The components of the first CPU ISA objects 42A and links between them have the same reference numerals as the components of the conceptual heterogeneous multiprocessor application 10 in FIG. 1, except that the first CPU ISA objects 42A and their links have been appended with “A” (e.g., “20” to “20A”). Similarly, the components of the second CPU ISA objects 42B are the same as the components of the heterogeneous multiprocessor application 10 in FIG. 1 except that they have been appended with “B” (e.g., “20” to “20B”).

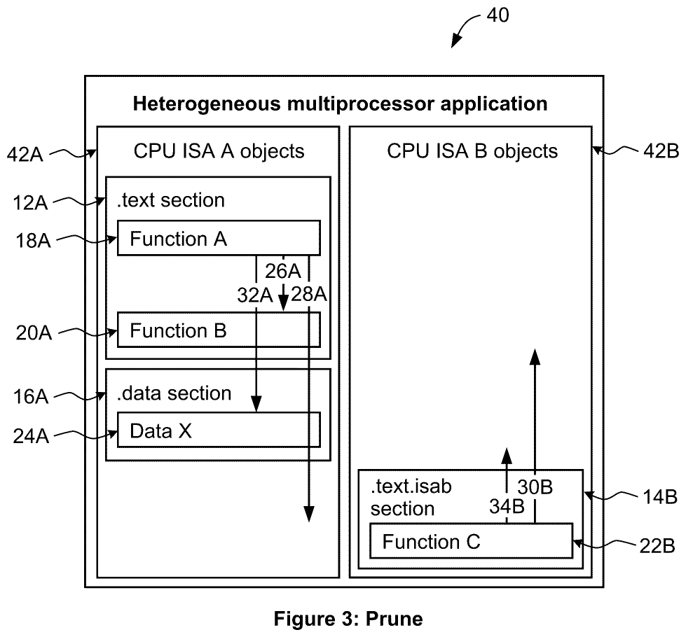

FIG. 3 illustrates a pruning operation that is carried out to construct the heterogeneous multiprocessor application 40. In the first CPU ISA objects 42A, the code 14A and the third function 22A are removed. The removal of the third function 22A also removes the link 34A to the data structure 24A. In the second CPU ISA objects 42B, the code 12B to run on the secondary ISA is removed, together with the first and second functions 18B and 20B. The common data 16B and the data structure 24B are also removed from the second CPU ISA objects 42B. Removal of the components from the second CPU ISA objects 42B also severs the links at 26B, 28B and 32B. The code 12A to run on the primary ISA has a “text” naming structure, referred to as a “linker input section”, “.text section” or “object file section”. The code 14B to run on the secondary ISA has a “text.isab” naming structure.

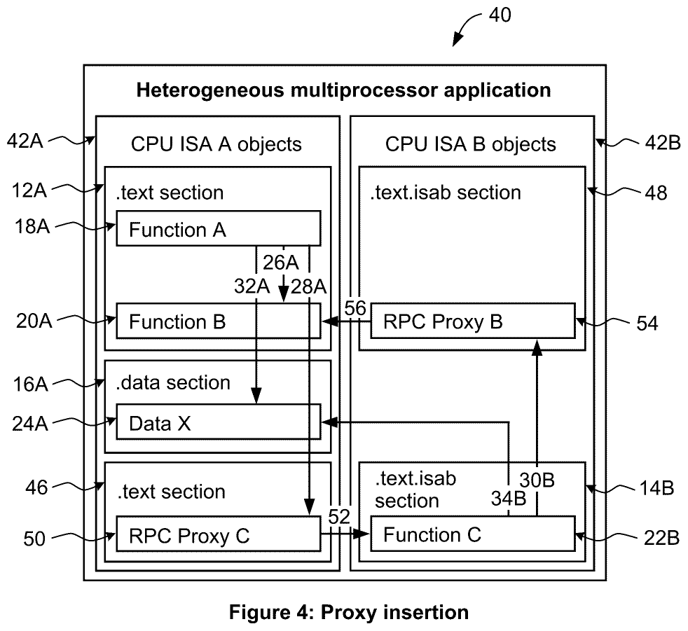

FIG. 4 illustrates a proxy insertion operation that is carried out in the construction of the heterogeneous multiprocessor application 40. First and second proxy sections 46 and 48 are inserted into the first and second CPU ISA objects 42A and 42B, respectively. The first proxy section 46 includes a first remote procedure call (RPC) 50. The first function 18A points to the first RPC 50. The first RPC 50, at 52, points to the third function 22B of the second CPU ISA objects 42B. In practice, the third function 22A in FIG. 2 can be replaced with the first RPC 50 in FIG. 4.

The second proxy section 48 includes a second remote procedure call (RPC) 54. The third function 22B points to the second RPC 54 at 30B. The second RPC 54, at 56, points to the second function 20A in FIG. 4. The second proxy section 48 has not, at this time, been renamed and the link 56 is thus not active. The link 56 is however included in FIG. 4 to illustrate the eventual functioning of the heterogeneous multiprocessor application 40 after the second proxy section 48 has been renamed. Similarly, the link 34B is shown to point to the data structure 24A to illustrate the eventual functioning of the heterogeneous multiprocessor application 40 after the code 14B to run on the secondary ISA has been renamed.

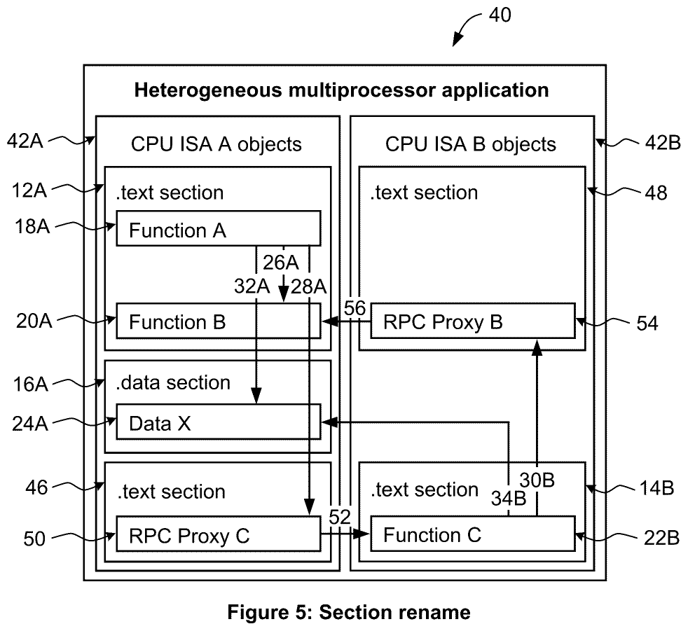

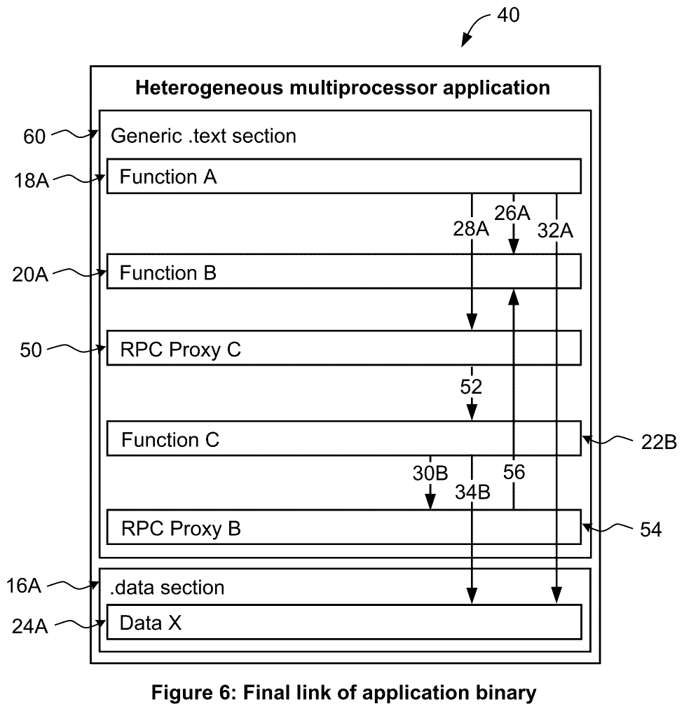

FIG. 5 illustrates a section rename operation that is carried out to construct the heterogeneous multiprocessor application 40. The code 14B to run on the secondary ISA and the second proxy section 48 are renamed from “.text.isab” to “.text” to be consistent with the naming of the first CPU ISA objects 42A. FIG. 6 illustrates the final links in the application library after the section renaming in FIG. 5. The section renaming creates a generic “.text” section 60 that contains the first, second and third functions 18A, 20A and 22B and the first and second RPC's 50 and 54.

The source code may for example be written in C++ code, whereafter the processing threads as represented by the first, second and third functions 18A, 20A and 24A in FIG. 2 invisibly transition in what can be referred to as a “weave” event from one binary incompatible core to another at procedure called boundaries. The software author may first focus on functional correctness using conventional high-level C++ threading primitives and libraries, and may then, in a modular way, migrate individual blocks of code to the more efficient processor without having to rewrite the code or having to rely on different sets of libraries. A system may, for example, have a digital signal processor (DSP) and a general purpose central processing unit (CPU). From a software author's point of view, to run a function on the DSP, all that would need to be done would be to add an attribute tag to a function specifying that it be placed in a specific non-“.text” program section as follows:

#define ML_ON_DSP _attribute_ ((section (“.text_dsp”)))
...
ML_ON_DSP int foo(void) {
return 42;
}

In the above example, after compiling the source file, the resultant object file would contain the function “foo” in the “.text_dsp” section. The build system recognizes and strips the “.text_dsp” section from the object file, then recompiles the source file for the DSP's ISA. Any references to the “foo” function would be replaced with a shim function to initiate a remote procedure call on the DSP. In a similar manner, the reverse would occur for the DSP object file: any functions in .text would be stripped and any references to them in functions in the .text_dsp section would be replaced with a shim function to initiate a remote procedure call back onto the CPU. As long as the two processors have identical compiled structural layouts, have identical views to the same virtual memory, and have coherent caches at the time of a weave event, an application should be able to seamlessly transition from one processor architecture to the other while maintaining a simple and coherent programmer view of the flow of execution.

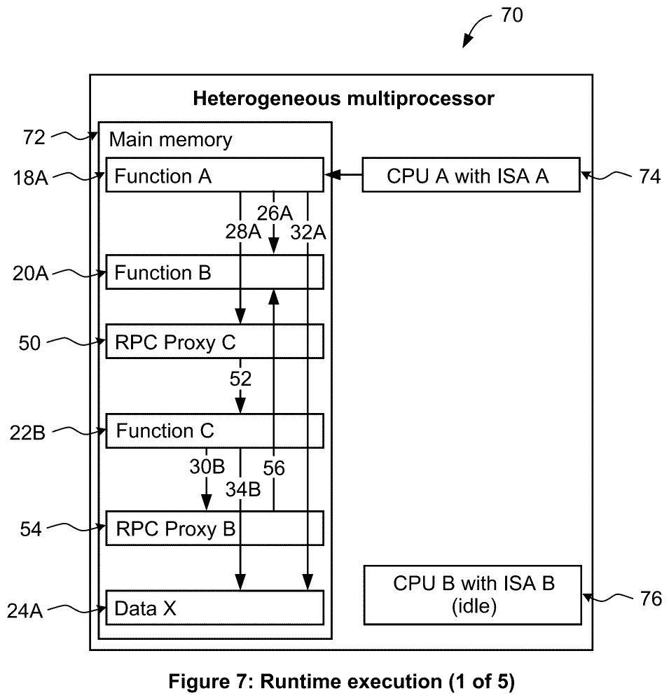

FIG. 7 illustrates a first operation that is carried out during runtime execution. A heterogeneous multiprocessor 70 has a main memory 72 that stores the components of the heterogeneous multiprocessor application 40 of FIG. 6. The first function 18A is the main function that is executed to run the application. The block 74 indicates that the first function 18A is executed on a first processor using the first CPU ISA objects. The block 76 indicates that the second processor that uses the second CPU ISA objects is idle. The first function 18A, at 32A, relies on the data structure 24A, e.g. for purposes of looking up data. The first function 18A, at 26A and 26B, executes the second function 20A and the first RPC 50.

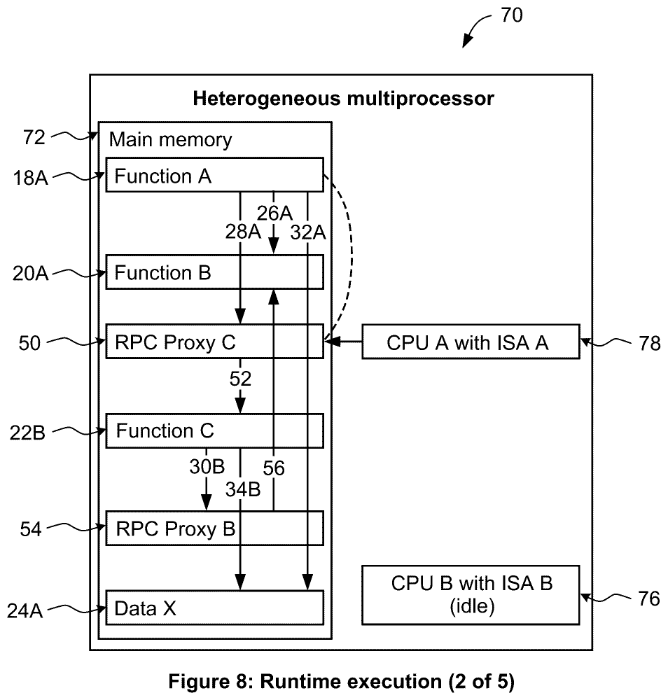

FIG. 8 illustrates a second process that is executed on the heterogeneous multiprocessor 70 when the first function 18A initiates the first RPC 50. The block 78 indicates that the first RPC 50 is executed on the first CPU using the first ISA objects. The block 78 indicates that the second CPU is still idle. The first RPC 50, at 52, executes the third function 22B.

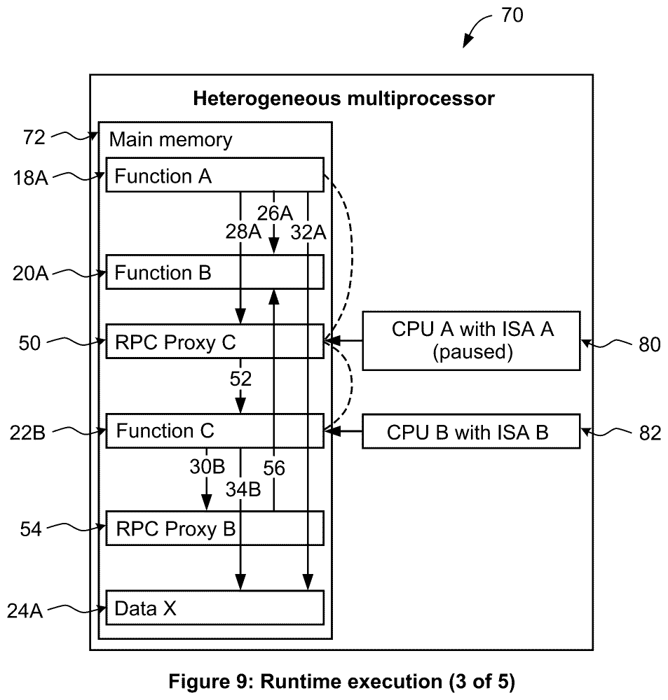

FIG. 9 illustrates a third operation that is executed on the heterogeneous multiprocessor 70 when the first RPC 50 executes the third function 22B. The block 80 indicates that the first CPU that uses the first ISA objects is paused. The block 82 indicates that the third function 22B is executed with the second CPU using the second ISA objects. The third function 22B, at 34B, utilizes the data structure 24A, e.g. for purposes of executing a lookup. The third function 22B, at 30B, executes the second RPC 54.

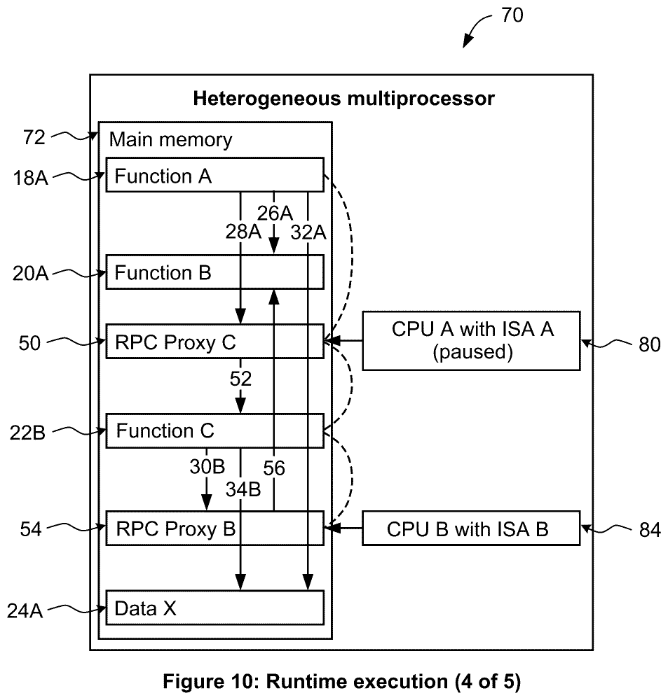

FIG. 10 illustrates a fourth operation that is executed on the heterogeneous multiprocessor 70 when the second RPC 54 is executed. Block 80 indicates that the first CPU is still paused. Block 84 indicates that the second RPC 54 is executed with the second CPU using the second ISA objects. The second RPC 54, at 56, executes the second function 20A.

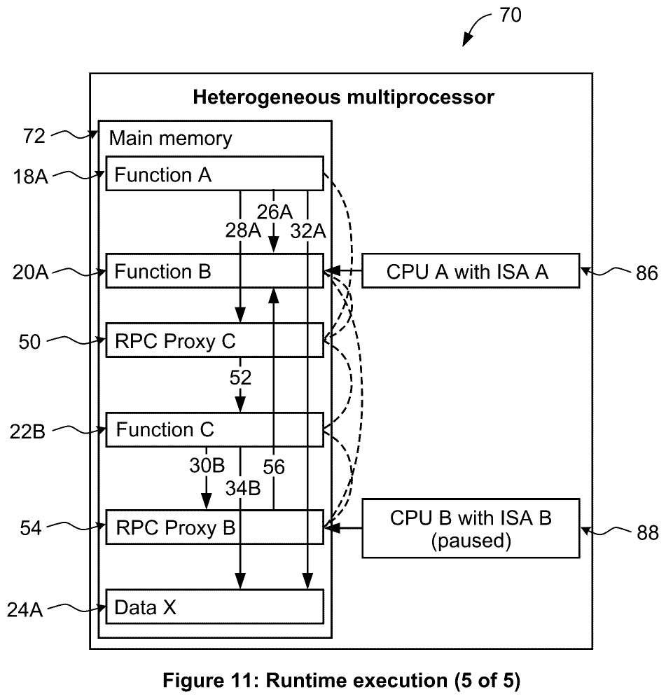

FIG. 11 illustrates a fifth operation that is executed on the heterogeneous multiprocessor 70 when the second function 20A is executed. The block 86 indicates that the first function 20A is executed with the first CPU using the first ISA objects. The block 88 indicates that the second CPU is paused.

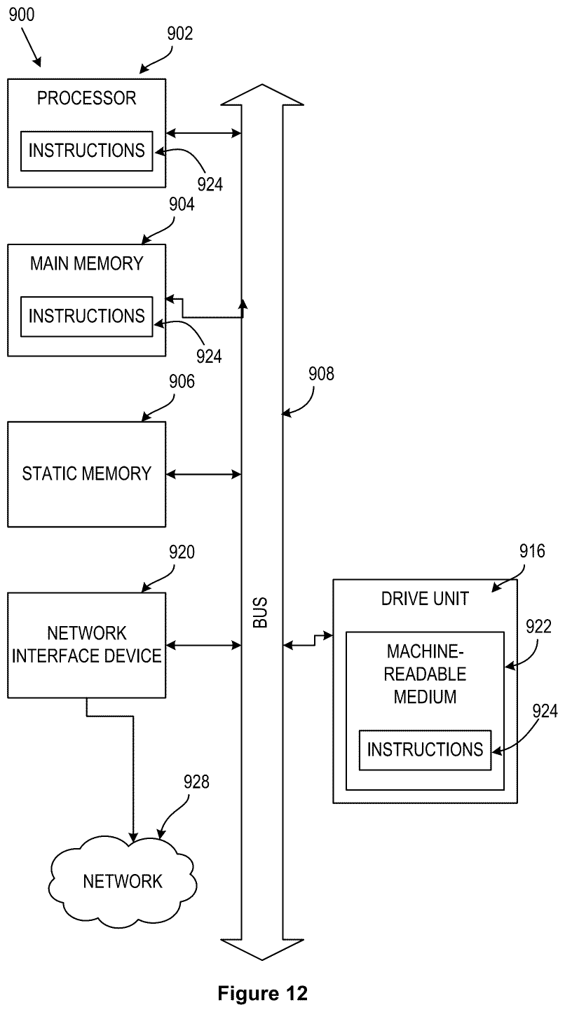

FIG. 12 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 902 (e.g., a central processing unit (CPU), a graphics processing unit (GPU) or both), a main memory 904 (e.g., read only memory (ROM), flash memory, dynamic random access memory (DRAM) such as synchronous DRAM (SDRAM) or Rambus DRAM (RDRAM), etc.), and a static memory 906 (e.g., flash memory, static random access memory (SRAM), etc.), which communicate with each other via a bus 908.

The computer system 900 may further include a disk drive unit 916, and a network interface device 920.

The disk drive unit 916 includes a machine-readable medium 922 on which is stored one or more sets of instructions 924 (e.g., software) embodying any one or more of the methodologies or functions described herein. The software may also reside, completely or at least partially, within the main memory 904 and/or within the processor 902 during execution thereof by the computer system 900, the main memory 904 and the processor 902 also constituting machine-readable media.

The software may further be transmitted or received over a network 928 via the network interface device 920.

While the machine-readable medium 922 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A heterogeneous multiprocessor comprising:
first and second heterogeneous processors;
a memory; and
an application on the memory, including:
first, second and third functions and first and second remote proxy calls (RPC), wherein
(1) the first function is a main function that is executed on the first processor with at least one of first central processing unit (CPU) in structural set architecture (ISA) objects that are compiled to the first processor, the main function causing sequential execution of:
(2) the first RPC on the first processor with at least one of the first CPU ISA objects;
(3) the third function on a second processor with at least one of second CPU ISA objects that are compiled to the second processor;
(4) the second RPC on the second processor with at least one of the second CPU ISA objects; and
(5) the second function on the first processor with at least one of the first CPU ISA objects,
wherein the application has a data section that is used by functions of the first and second CPU ISA objects.

2. The heterogeneous multiprocessor of claim 1, wherein the first function points to the second function.

3. The heterogeneous multiprocessor of claim 1, wherein the first function points to the first RPC.

4. The heterogeneous multiprocessor of claim 1, wherein the first function uses the data section.

5. The heterogeneous multiprocessor of claim 1, wherein the third function uses the data section.
